(19) United States
(12) Patent Application Publication
(10) Pub. No.: US 2018/0142761 A1
(43) Pub. Date: May 24, 2018

(54) POWER TRANSMISSION DEVICE

(71) Applicant: EXEDY Corporation, Neyagawa-shi, Osaka (JP)

(72) Inventor: Hiroshi UEHARA, Neyagawa-shi, Osaka (JP)

(21) Appl. No.: 15/580,164

(22) PCT Filed: Aug. 10, 2016
(86) PCT No.: PCT/JP2016/073550

§ 371 Date: Dec. 6, 2017

(30) Foreign Application Priority Data
Sep. 18, 2015 (JP) 2015-185062

(51) Int. Cl. F16F 15/134; F16F 15/30; F16F 15/139

(52) U.S. Cl. CPC F16F 15/134; F16F 15/139; F16F 15/30

(57) ABSTRACT

A power transmission device is disposed between an engine and a transmission so as to be capable of attenuating fluctuations in torque. The device includes an input rotary part, an output rotary part, an elastic part, an inertia mass part and an engaging part. The torque is inputted to the input rotary part. The output rotary part is rotatable relatively to the input rotary part. The elastic part elastically couples the input rotary part and the output rotary part in a rotational direction. The inertia mass part is movable in the rotational direction. The engaging part is engaged with the elastic part and the inertia mass part. The engaging part actuates the elastic part by relative rotation between the input rotary part and the output rotary part and movement of the inertia mass part.

### CROSS-REFERENCES TO RELATED APPLICATIONS

This application is the U.S. National Phase of PCT International Application No. PCT/JP2016/073550 filed on Aug. 10, 2016. That application claims priority to Japanese Patent Application No. 2015-185062, filed on Sep. 18, 2015. The contents of both applications are herein incorporated by reference in their entirety.

### BACKGROUND

### Technical Field

The present disclosure relates to a power transmission device, particularly to a power transmission device disposed between an engine and a transmission so as to be capable of attenuating fluctuations in torque.

### Background Art

There has been conventionally disclosed a type of power transmission device disposed between an engine and a transmission so as to be capable of attenuating fluctuations in torque (see Japan Laid-open Patent Application Publication No. 2015-014358). The conventional type of power transmission device includes an input rotary part (28), an output rotary part (33), first elastic parts (29, 32), an intermediate member (31), inertia mass parts (53, 54) and second elastic parts (55). The first elastic parts elastically couple the input rotary part and the output rotary part in a rotational direction. The intermediate member couples the first elastic parts in series. The second elastic parts couple the intermediate member and the inertia mass parts. In this case, the inertia mass parts (53, 54) and the second elastic parts (55) function as a dynamic damper device (34).

### BRIEF SUMMARY

In the conventional type of power transmission device, the first elastic parts function as elastic parts for torque transmission and the second elastic parts function as elastic parts for a dynamic damper. When the power transmission device is thus configured, not only the inertia mass parts but also the second elastic parts are required to be prepared for making the dynamic damper device function. This poses drawbacks including complexity in configuration of the power transmission device and increase in size of the power transmission device.

The present disclosure has been made in view of the aforementioned drawbacks. It is an object of the present disclosure to provide a power transmission device in which an inertia mass body can be actuated with a simple configuration. Besides, it is another object of the present disclosure to provide a power transmission device that can be made compact.

### Solution to Problems

A power transmission device according to an aspect of the present disclosure is disposed between an engine and a transmission so as to be capable of attenuating fluctuations in torque. The present power transmission device includes an input rotary part, an output rotary part, an elastic part, an inertia mass part and an engaging part. The input rotary part is a component to which the torque is inputted. The output rotary part is rotatable relatively to the input rotary part. The elastic part elastically couples the input rotary part and the output rotary part in a rotational direction. The inertia mass part is movable in the rotational direction. The engaging part is engaged with the elastic part and the inertia mass part. The engaging part actuates the elastic part by relative rotation between the input rotary part and the output rotary part and movement of the inertia mass part.

In the present power transmission device, torque fluctuations can be attenuated when the engaging part actuates the elastic part by the relative rotation between the input rotary part and the output rotary part. Additionally, torque fluctuations can be also attenuated when the engaging part actuates the elastic part by the movement of the inertia mass part. Thus, in the present power transmission device, torque fluctuations can be attenuated without specially preparing an elastic part for actuating the inertia mass part. In other words, in the present power transmission device, torque fluctuations can be also attenuated in movement of the inertia mass part only by the elastic part that elastically couples the input rotary part and the output rotary part. Put differently, in the present power transmission device, the inertia mass body can be actuated with a simple configuration. Besides, the present power transmission device can be made compact.

In a power transmission device according to another aspect of the present disclosure, the engaging part is capable of compressing the elastic part by the relative rotation between the input rotary part and the output rotary part. Additionally, the engaging part is capable of bending the elastic part by the movement of the inertia mass part.

In this case, the engaging part is capable of compressing the elastic part by the relative rotation between the input rotary part and the output rotary part. Hence, torque fluctuations can be attenuated by compressive deformation of the elastic part. Additionally, the engaging part is capable of bending the elastic part by the movement of the inertia mass part. Hence, torque fluctuations can be attenuated by bending deformation of the elastic part. In this way, in the present power transmission device, torque fluctuations can be attenuated by utilizing the compressive deformation and bending deformation of the elastic part. Thus, in the present power transmission device, torque fluctuations can be also attenuated in movement of the inertia mass part only by the elastic part that elastically couples the input rotary part and the output rotary part. Put differently, in the present power transmission device, the inertia mass body can be actuated with a simple configuration. Besides, the present power transmission device can be made compact.

In a power transmission device according to yet another aspect of the present disclosure, the engaging part is pivotably engaged with the inertia mass part. In this case, when the inertia mass part is moved in the rotational direction, the engaging part is pivoted with respect to the inertia mass part. The elastic part can be bent and deformed by the pivot of the engaging part.

In a power transmission device according to yet another aspect of the present disclosure, the engaging part makes contact with the elastic part. Therefore, the elastic part can be reliably pressed by the engaging part, and can be thereby compressed and deformed. Additionally, the elastic part can be stably bent and deformed by the engaging part.

A power transmission device according to yet another aspect of the present disclosure further includes a positioning part. The positioning part positions the engaging part in a radial direction. In this case, radial movement of the engaging part can be restricted by the positioning part. Hence, the elastic part can be reliably compressed and deformed, and besides, can be stably bent and deformed.

In a power transmission device according to yet another aspect of the present disclosure, the positioning part further positions the elastic part in the radial direction. In this case, while held by the positioning part in the radial direction, the elastic part can be reliably compressed and deformed, and besides, can be stably bent and deformed.

In a power transmission device according to yet another aspect of the present disclosure, the inertia mass part is disposed radially inside the engaging part. Accordingly, the power transmission device can be further made compact.

In a power transmission device according to yet another aspect of the present disclosure, the inertia mass part has an annular shape. Accordingly, the inertia mass part can be stably actuated in the rotational direction.

In a power transmission device according to yet another aspect of the present disclosure, the elastic part includes a first elastic part and a second elastic part. The second elastic part is actuated in series with the first elastic part. The engaging part is disposed between the first elastic part and the second elastic part.

Even with this configuration, torque fluctuations can be attenuated only by the elastic part that elastically couples the input rotary part and the output rotary part without specially preparing an elastic part for actuating the inertia mass part. Put differently, in the present power transmission device, the inertia mass body can be actuated with a simple configuration. Besides, the present power transmission device can be made compact.

According to the present disclosure, in a power transmission device, an inertia mass body can be actuated with a simple configuration. Besides, according to the present disclosure, the power transmission device can be made compact.

### BRIEF DESCRIPTION OF THE DRAWINGS

FIG. 1 is a partial front view of a power transmission device according to an exemplary embodiment of the present disclosure (except for a second flywheel).

FIG. 2A is a cross-sectional view of the power transmission device taken along cutaway line A-O-B.

FIG. 2B is a cross-sectional view of the power transmission device taken along cutaway line O-C.

FIG. 3A is a diagram for explaining how a second spring seat (an engaging part) is actuated.

FIG. 3B is a diagram for explaining how the second spring (the engaging part) is actuated.

FIG. 4 is a characteristic diagram of engine rotational speed and fluctuations in engine rotational speed.

### DETAILED DESCRIPTION OF EMBODIMENTS

[Entire Configuration]

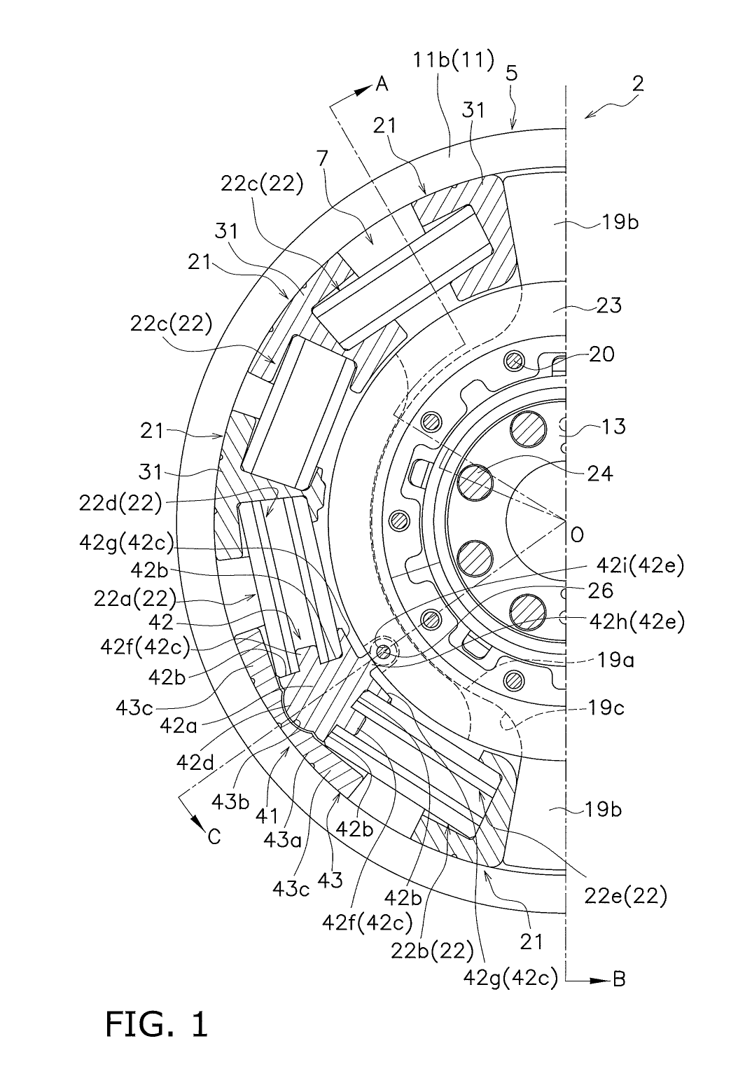

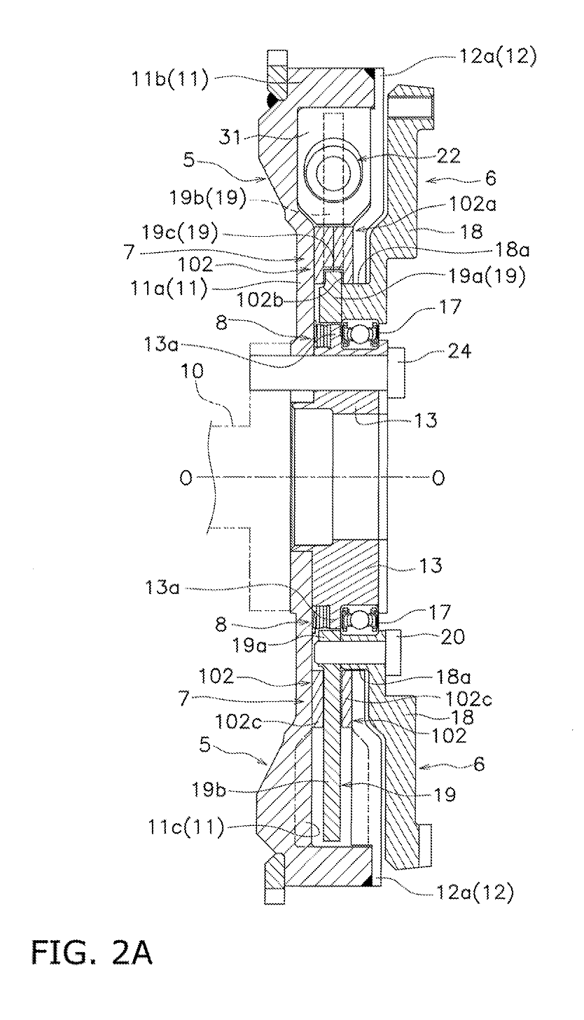

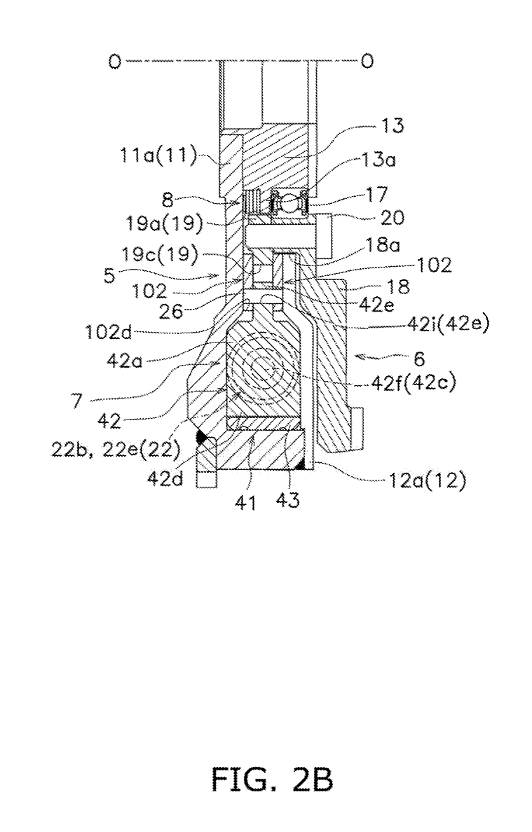

FIGS. 1, 2A and 2B are a front view and cross-sectional views of a flywheel assembly 2 according to an exemplary embodiment of the present disclosure. The flywheel assembly 2 is an exemplary power transmission device.

In FIGS. 2A and 2B, line O-O is a rotational axis. An engine is disposed on the left side in FIGS. 2A and 2B, whereas a transmission is disposed on the right side in FIGS. 2A and 2B. Detailedly, the engine is disposed on the left side in FIGS. 2A and 2B, whereas a clutch device is disposed on the right side in FIGS. 2A and 2B. The engine, the transmission and the clutch device are not shown in the drawings.

[Flywheel Assembly]

The flywheel assembly 2 is disposed between the engine and the transmission. A torque is inputted to the flywheel assembly 2 from the engine. The torque, outputted from the flywheel assembly 2, is transmitted to the clutch device.

The flywheel assembly 2 is capable of attenuating fluctuations in torque, while being disposed between the engine and the transmission. As shown in FIGS. 1, 2A and 2B, the flywheel assembly 2 includes a first flywheel 5 (an exemplary input rotary part), a second flywheel 6 (an exemplary output rotary part), a damper mechanism 7 and a hysteresis torque generating mechanism 8.

<First Flywheel>

The first flywheel 5 is a member to which a power from the engine is inputted. The power from the engine is inputted to the first flywheel 5. The first flywheel 5 is fixed to a crankshaft 10 of the engine.

As shown in FIGS. 1, 2A and 2B, the first flywheel 5 includes a first plate 11, a second plate 12 and a support member 13.

The first plate 11 includes a disc part 11a having a hole in the rotational center thereof and a first tubular part 11b extending from the outer peripheral end of the disc part 11a toward the transmission. The inner peripheral part of the first plate 11 is fixed, together with the support member 13, to the crankshaft 10 by fixation members such as bolts 24.

The outer peripheral part of the first plate 11 includes power transmission parts 11c. The power transmission parts 11c are parts that transmit the power from the engine to the damper mechanism 7. The power transmission parts 11c are capable of pressing spring seats 21 (first spring seats 31 to be described) of the damper mechanism 7. Detailedly, each power transmission part 11c is made in the shape of a step. The first spring seats 31 are contactable to the walls of the power transmission parts 11c. The first spring seats 31 are pressed by the walls of the power transmission parts 11c, whereby the power from the engine is transmitted from the first plate 11 to the damper mechanism 7.

Here, the first spring seats 31, which make contact with the walls of the step-shaped power transmission parts 11c, respectively, are those contactable to protruding parts 19b (to be described) of the second flywheel 6.

The second plate 12 is an annular member and includes a disc part 12a having a hole in the rotational center thereof. The disc part 12a of the second plate 12 is disposed axially in opposition to the disc part 11a of the first plate 11. The outer peripheral end of the disc part 12a is welded to the axially distal end of the first tubular part 11b of the first plate 11.

The support member 13 is a tubular member. As described above, the support member 13 is fixed, together with the first plate 11, to the crankshaft 10 by the fixation members such as the bolts 24.

<Second Flywheel>

The second flywheel 6 is disposed to be rotatable relatively to the first flywheel 5. Specifically, as shown in FIGS. 2A and 2B, the second flywheel 6 is rotatably supported by the support member 13 through a bearing 17 disposed on the outer periphery of the support member 13. The second flywheel 6 includes a body plate 18 and a flange plate 19.

The body plate 18 is an annular member. The body plate 18 is disposed on the transmission side (the clutch device side) of the second plate 12. The body plate 18 includes a second tubular part 18a extending from the inner peripheral end thereof toward the engine. The second tubular part 18a is fixed to the flange plate 19 by fixation members such as bolts 20. The bearing 17 is disposed on the inner peripheral side of the second tubular part 18a. The body plate 18 is rotatably supported by the support member 13 through the bearing 17.

The flange plate 19 is disposed axially between the first plate 11 and the second plate 12. The flange plate 19 has an annular shape.

As shown in FIGS. 1, 2A and 2B, the flange plate 19 includes an annular part 19a, a plurality of (e.g., two) protruding parts 19b and a plurality of (e.g., two) cutouts 19c. It should be noted that FIG. 1 shows only one of the two cutouts 19c.

The annular part 19a is an annular part provided as an inner peripheral part of the flange plate 19. The annular part 19a is fixed to the body plate 18 by the fixation members such as the bolts 20. The protruding parts 19b are parts protruding radially outward from the annular part 19a. The protruding parts 19b are provided on the annular part 19a. Detailedly, the protruding parts 19b are integrated with the outer peripheral part of the annular part 19a, while being disposed at intervals in the circumferential direction. The protruding parts 19b are herein integrated with the outer peripheral part of the annular part 19a, while being disposed at angular intervals of substantially 180 degrees in the circumferential direction.

The cutouts 19c are parts provided between the protruding parts 19b disposed adjacently to each other in the circumferential direction. The cutouts 19c are provided on the annular part 19a. Detailedly, each cutout 19c is composed of the circumferentially lateral parts of the protruding parts 19b and the outer peripheral part of the annular part 19a. A plurality of torsion springs 22 and the plurality of spring seats 21 (to be described) are disposed in the cutouts 19c.

<Damper Mechanism>

The damper mechanism 7 is a mechanism that elastically couples the first flywheel 5 and the second flywheel 6. Detailedly, the damper mechanism 7 is a mechanism that elastically couples the first plate 11 and the second plate 12 in a rotational direction.

As shown in FIGS. 2A and 2B, the damper mechanism 7 is disposed between the first flywheel 5 and the second flywheel 6. Detailedly, the damper mechanism 7 is disposed axially between the first plate 11 and the second plate 12.

As shown in FIGS. 1, 2A and 2B, the damper mechanism 7 includes a plurality of (e.g., eight) torsion springs 22 (exemplary elastic parts), a plurality of (e.g., ten) spring seats 21 and an inertia member 23 (an exemplary inertia mass part).

It should be noted that FIG. 1 shows four of the eight torsion springs 22 and five of the ten spring seats 21.

Torsion Springs

The plural torsion springs 22 are provided for causing the first flywheel 5 and the second flywheel 6 to be elastically actuated in the rotational direction. As shown in FIGS. 1, 2A and 2B, the plural torsion springs 22, for instance, six torsion springs 22 are accommodated in each of the cutouts 19c of the second flywheel 6 (the flange plate 19). The six torsion springs 22 are disposed in circumferential alignment within each of the cutouts 19c. Four torsion springs 22 (22a, 22b, 22c) of the six torsion springs 22 are disposed in series. Two torsion springs 22 (22d, 22e) of the six torsion springs 22 are disposed in the inner peripheral parts of the torsion springs 22 (22a, 22b), respectively.

Specifically, as shown in FIG. 1, four of the six torsion springs 22 include a first torsion spring 22a (an exemplary first elastic part), a second torsion spring 22b (an exemplary second elastic part) and two third torsion springs 22c. The first to third torsion springs 22a, 22b and 22c are disposed in series and are actuated in series.

A fourth torsion spring 22d (an exemplary first elastic part) is disposed in the inner peripheral part of the first torsion spring 22a. On the other hand, a fifth torsion spring 22e (an exemplary second elastic part) is disposed in the inner peripheral part of the second torsion spring 22b.

The first torsion spring 22a and the second torsion spring 22b are a pair of torsion springs disposed on both sides of each of second spring seats 41 (to be described) in the circumferential direction. Likewise, the fourth torsion spring 22d and the fifth torsion spring 22e are a pair of torsion springs disposed on both sides of each of the second spring seats 41 (to be described) in the circumferential direction.

Among the six torsion springs 22, the two third torsion springs 22c are remaining torsion springs excluding the first and second torsion springs 22a and 22b and the fourth and fifth torsion springs 22d and 22e.

In the present exemplary embodiment, the flange plate 19 is provided with the two cutouts 19c. Hence, the six torsion springs 22 (first to fifth torsion springs 22a, 22b, 22c, 22d and 22e) are disposed in each of the cutouts 19c. In other words, the six torsion springs 22 (the first to fifth torsion springs 22a, 22b, 22c, 22d and 22e) are disposed between the pair of protruding parts 19b disposed circumferentially adjacent to each other in the second flywheel 6 (the flange plate 19).

Spring Seats

As shown in FIG. 1, the spring seats 21 couple the plural torsion springs 22 to each other, which are disposed in circumferential alignment in each of the cutouts 19c. The spring seats 21 hold both ends of the torsion springs 22 so as to be capable of pressing the torsion springs 22. The spring seats 21 are restricted from moving radially outward by the first flywheel 5. Detailedly, the spring seats 21 are capable of sliding against the inner peripheral part of the first tubular part 11b of the first plate 11, and besides, are restricted from moving radially outward by the first tubular part 11b of the first plate 11.

The plural spring seats 21 are disposed in the cutouts 19c of the second flywheel 6 (the flange plate 19). Additionally, the spring seats 21 are disposed on both ends of the respective torsion springs 22 (both ends of the first to fifth torsion springs 22a, 22b, 22c, 22d and 22e).

The plural spring seats 21 include a plurality of (e.g., eight) first spring seats 31 and a plurality of (e.g., two) second spring seats 41.

In the present exemplary embodiment, the flange plate 19 is provided with the two cutouts 19c. Hence, four first spring seats 31 and one second spring seat 41 are disposed in each of the cutouts 19c. In other words, the four first spring seats 31 and the one second spring seat 41 are disposed between the pair of protruding parts 19b disposed circumferentially adjacent to each other in the second flywheel 6 (the flange plate 19).

One first spring seat 31 is disposed between circumferentially adjacent two of the third torsion springs 22c, whereas another first spring seat 31 is disposed between one of these third torsion springs 22c and the first torsion spring 22a (the fourth torsion spring 22d) that are disposed circumferentially adjacent to each other. Additionally, yet another first spring seat 31 is disposed between the other of the aforementioned circumferentially adjacent third torsion springs 22c and one of the protruding parts 19b of the second flywheel 6 (the flange plate 19) that are disposed circumferentially adjacent to each other. Moreover, further yet another first spring seat 31 is disposed between the other of the protruding parts 19b of the second flywheel 6 (the flange plate 19) and the second torsion spring 22b (the fifth torsion spring 22e) that are disposed circumferentially adjacent to each other.

The first spring seats 31 disposed as described above hold the ends of the first to fifth torsion springs 22a, 22b, 22c, 22d and 22e, respectively, and are capable of pressing the first to fifth torsion springs 22a, 22b, 22c, 22d and 22e, respectively.

As shown in FIG. 1, the second spring seat 41 is disposed between circumferentially adjacent sets of torsion springs composed of the set of first and fourth torsion springs 22a and 22d and the set of second and fifth torsion springs 22b and 22e. In FIG. 1, the spring seat located in the position of eight o'clock corresponds to the second spring seat 41.

The second spring seat 41 disposed as described above holds one end of the set of first and fourth torsion springs 22a and 22d and that of the set of second and fifth torsion springs 22b and 22e. Additionally, the second spring seat 41 is capable of pressing the set of first and fourth torsion springs 22a and 22d and the set of second and fifth torsion springs 22b and 22e.

The second spring seat 41 includes an engaging part 42 and a positioning part 43. The engaging part 42 is engaged with the inertia member 23 and the torsion springs 22 (the set of first and second torsion springs 22a and 22b and the set of fourth and fifth torsion springs 22d and 22e).

The engaging part 42 enables the set of first and fourth torsion springs 22a and 22d and the set of second and fifth torsion springs 22b and 22e to be actuated by relative rotation between the first flywheel 5 and the second flywheel 6. Additionally, the engaging part 42 enables the set of first and fourth torsion springs 22a and 22d and the set of second and fifth torsion springs 22b and 22e to be actuated by rotation-directional movement of the inertia member 23.

Detailedly, the engaging part 42 is capable of compressing the set of first and fourth torsion springs 22a and 22d and the set of second and fifth torsion springs 22b and 22e by the relative rotation between the first flywheel 5 and the second flywheel 6. Additionally, the engaging part 42 is capable of bending the set of first and fourth torsion springs 22a and 22d and the set of second and fifth torsion springs 22b and 22e by the rotation-directional movement of the inertia member 23.

The engaging part 42 is engaged with one end of the set of first and fourth torsion springs 22a and 22d and that of the set of second and fifth torsion springs 22b and 22e. Additionally, the engaging part 42 is pivotably engaged with the inertia member 23.

Specifically, the engaging part 42 includes a first body 42a, a first contact part 42b, a first spring holding part 42c, a first curved part 42d and a coupling part 42e. The first body 42a is disposed between the first torsion spring 22a and the second torsion spring 22b.

The first contact part 42b is provided on the first body 42a. The first contact part 42b makes contact with the one end of the set of first and fourth torsion springs 22a and 22d and that of the set of second and fifth torsion springs 22b and 22e. Accordingly, the first contact part 42b is capable of pressing the set of first and fourth torsion springs 22a and 22d and the set of second and fifth torsion springs 22b and 22e.

The first spring holding part 42c is engaged with the set of first and fourth torsion springs 22a and 22d and the set of second and fifth torsion springs 22b and 22e. Accordingly, the first spring holding part 42c holds the set of first and fourth torsion springs 22a and 22d and the set of second and fifth torsion springs 22b and 22e.

Specifically, the first spring holding part 42c includes a pair of shaft parts 42f and a pair of brim parts 42g. Each of the pair of shaft parts 42f is provided on the first contact part 42b so as to protrude therefrom. One of the pair of shaft parts 42f is disposed in the inner peripheral part of the fourth torsion spring 22d. The other of the pair of shaft parts 42f is disposed in the inner peripheral part of the fifth torsion spring 22e.

The pair of brim parts 42g is provided on the inner peripheral part of the first body 42a so as to protrude therefrom. One of the pair of brim parts 42g holds the first torsion spring 22a from the inner peripheral side. The other of the pair of brim parts 42g holds the second torsion spring 22b the inner peripheral side.

The first curved part 42d is a part to be engaged with the positioning part 43. The first curved part 42d is provided on the outer peripheral part of the first body 42a. The first curved part 42d has a shape protruding radially outward on the outer peripheral part of the first body 42a.

The coupling part 42e is a part to be coupled to the inertia member 23. The coupling part 42e is provided on the inner peripheral part of the first body 42a. Specifically, the coupling part 42e includes an arm part 42h. The arm part 42h is provided on the first body 42a so as to protrude radially inward therefrom. The arm part 42h includes a first coupling hole 42i in the distal end thereof. The first coupling hole 42i is provided for coupling the engaging part 42 to the inertia member 23 in a pivotable state. The first coupling hole 42i is disposed in opposition to second coupling holes 102d (to be described) of the inertia member 23. In this condition, a pivot shaft 26 is disposed in the first coupling hole 42i and the second coupling holes 102d. Accordingly, the engaging part 42 is pivotably attached to the inertia member 23.

The positioning part 43 radially positions the engaging part 42 and the torsion springs 22 (the set of first and fourth torsion springs 22a and 22d and the set of second and fifth torsion springs 22b and 22e).

Detailedly, the positioning part 43 radially positions the engaging part 42 such that the engaging part 42 is pivotable with respect to the inertia member 23. Additionally, the positioning part 43 radially positions the engaging part 42 such that the engaging part 42 is capable of pressing the set of first and fourth torsion springs 22a and 22d and the set of second and fifth torsion springs 22b and 22e.

As shown in FIG. 1, the positioning part 43 is restricted from moving radially outward by the first flywheel 5 (the first tubular part 11b of the first plate 11). The positioning part 43 is disposed radially between the first tubular part 11b of the first plate 11 and the engaging part 42. Additionally, the positioning part 43 is disposed radially between the first tubular part 11b of the first plate 11 and the one ends of the first and second torsion springs 22a and 22b.

The positioning part 43 includes a second body 43a, a recess 43b and a second spring holding part 43c. The second body 43a is restricted from moving radially outward by the first tubular part 11b of the first plate 11. The recess 43b is provided on the second body 43a. The recess 43b has a recessed shape so as to be fitted to the shape of the curved part 42d of the engaging part 42. The first curved part 42d of the engaging part 42 is disposed in the recess 43b. When the engaging part 42 is pivoted by the movement of the inertia member 23, the first curved part 42d is slid along the recess 43b. The second spring holding part 43c holds the one ends of the first and second torsion springs 22a and 22b from the outer peripheral side.

Inertia Member

The inertia member 23 is disposed to be movable in the rotational direction. As shown in FIGS. 1, 2A and 2B, the inertia member 23 is disposed radially inside the plural torsion springs 22 (the first to fifth torsion springs 22a, 22b, 22c, 22d and 22e). Additionally, the inertia member 23 is disposed radially inside the plural spring seats 21. Moreover, the inertia member 23 is disposed radially outside the support member 13.

As shown in FIG. 1, the inertia member 23 has an annular shape. As shown in FIGS. 2A and 2B, the inertia member 23 includes a pair of inertia rings 102. The pair of inertia rings 102 is disposed in axial opposition to each other. The pair of inertia rings 102 has the same configuration.

Specifically, each of the pair of inertia rings 102 includes second contact parts 102a (see the upper side of line O-O in FIG. 2A), step parts 102b (see the upper side of line O-O in FIG. 2A), opposed parts 102c (see the lower side of line O-O in FIG. 2A) and the second coupling holes 102d (see FIG. 2B).

As shown in FIG. 2A, each pair of second contact parts 102a axially makes contact with each other. Each pair of step parts 102b form a recess while each pair of second contact parts 102a makes contact with each other. The bottom part of each cutout 19c of the flange plate 19 is disposed in each pair of step parts 102b (each recess). Each pair of opposed parts 102c is disposed axially at a predetermined interval while each pair of second contact parts 102a makes contact with each other. Each protruding part 19b of the flange plate 19 is disposed between each pair of opposed parts 102c.

As shown in FIG. 2B, each pair of second coupling holes 102d is provided for coupling each engaging part 42 to the pair of inertia rings 102 in a pivotable state. Each of each pair of second coupling holes 102d is provided in each of each pair of opposed parts 102c. The coupling part 42e of each engaging part 42 is disposed axially between each pair of opposed parts 102c. In this condition, each pivot shaft 26 is fixed to each pair of second coupling holes 102d while being inserted through each pair of second coupling holes 102d and the first coupling hole 42i, whereby each engaging part 42 is pivotably attached to the pair of inertia rings 102.

Additionally, the pair of inertia rings 102 is radially positioned by the second flywheel 6. Detailedly, as shown in FIG. 2A, the inner peripheral part of one of the inertia rings 102 makes contact with the second tubular part 18a of the second flywheel 6 (the body plate 18), whereby the pair of inertia rings 102 is radially positioned.

<Hysteresis Torque Generating Mechanism>

The hysteresis torque generating mechanism 8 is disposed axially between the inner peripheral part of the first plate 11 and a flange part 13a provided on the outer peripheral part of the support member 13. The hysteresis torque generating mechanism 8 is composed of a plurality of annular plate members and a cone spring. In the hysteresis torque generating mechanism 8, friction resistance (hysteresis torque) is generated in the rotational direction by relative rotation between the first flywheel 5 and the second flywheel 6.

[Actions and Features]

First, when a power from the engine is transmitted to the first flywheel 5 and accordingly the first flywheel 5 and the second flywheel 6 are rotated relatively to each other, friction resistance (hysteresis torque) is generated in the hysteresis torque generating mechanism 8.

Next, the damper mechanism 7 is actuated by the relative rotation between the first flywheel 5 and the second flywheel 6. Specifically, when the power is transmitted from the power transmission parts 11c of the first flywheel 5 to the damper mechanism 7, the plural torsion springs 22 are pressed through the plural spring seats 21. Accordingly, the plural torsion springs 22 are compressed and deformed. Here, torque fluctuations in the relative rotation between the first flywheel 5 and the second flywheel 6 are inputted to the damper mechanism 7. Hence, the plural torsion springs 22 are extended and compressed. Accordingly, torsional vibrations in occurrence of torque fluctuations can be attenuated.

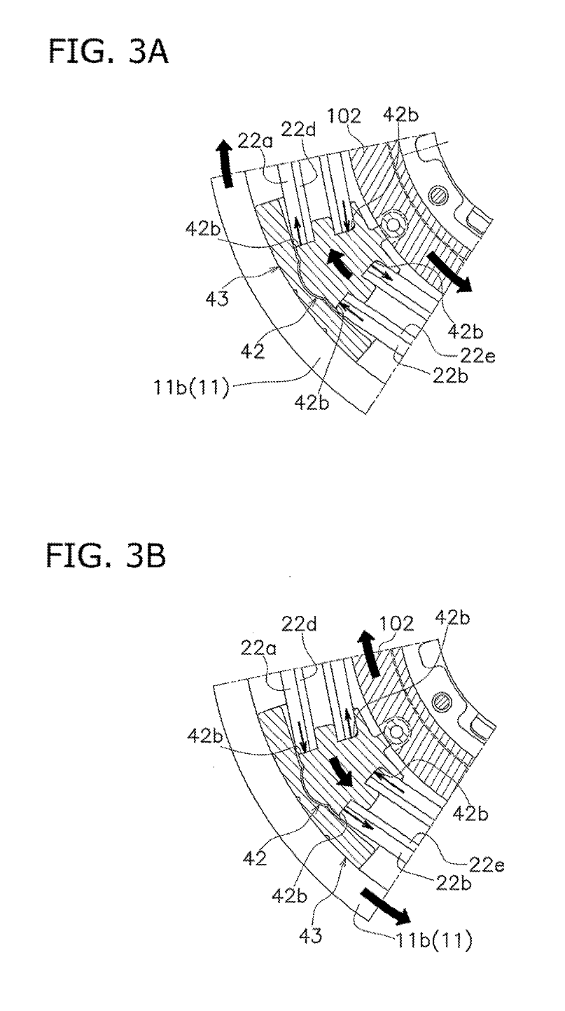

Subsequently, the inertia member 23 is capable of being actuated while the plural torsion springs 22 are being actuated. For example, when the inertia member 23 is moved in the opposite rotational direction to the rotational direction of the first flywheel 5, the engaging part 42 of each second spring seat 41 is pivoted with respect to the inertia member 23 by the movement of the inertia member 23 (see FIGS. 3A and 3B). Accordingly, the set of first and fourth torsion springs 22a and 22d and the set of second and fifth torsion springs 22b and 22e, both of which are engaged with the engaging part 42, are bent by the pivot of the engaging part 42.

More specifically, as described below, the engaging part 42 of each second spring seat 41 acts on the one end of the set of first and fourth torsion springs 22a and 22d and that of the set of second and fifth torsion springs 22b and 22e.

As shown in FIGS. 3A and 3B, one of the set of first and fourth torsion springs 22a and 22d and the set of second and fifth torsion springs 22b and 22e is pressed at the outer peripheral part of the one end thereof by the engaging part 42 (the first contact part 42b), whereas the other of the set of first and fourth torsion springs 22a and 22d and the set of second and fifth torsion springs 22b and 22e is pressed at the inner peripheral part of the one end thereof by the engaging part 42 (the first contact part 42b).

On the other hand, one of the set of first and fourth torsion springs 22a and 22d and the set of second and fifth torsion springs 22b and 22e presses the engaging part 42 (the first contact part 42b) at the inner peripheral part of the one end thereof. At this time, the other of the set of first and fourth torsion springs 22a and 22d and the set of second and fifth torsion springs 22b and 22e presses the engaging part 42 (the first contact part 42b) at the outer peripheral part of the one end thereof. Thus, the engaging part 42 acts on the set of first and fourth torsion springs 22a and 22d and the set of second and fifth torsion springs 22b and 22e, whereby the set of first and fourth torsion springs 22a and 22d and the set of second and fifth torsion springs 22b and 22e are bent and deformed.

The aforementioned action is achieved by causing the engaging part 42 of each second spring seat 41 to be engaged with the set of first and fourth torsion springs 22a and 22d and the set of second and fifth torsion springs 22b and 22e such that the engaging part 42 is capable of pressing both sets of springs, and also, by causing the engaging part 42 to be pivotably coupled to the inertia member 23.

Additionally, when the plural torsion springs 22 (the first to fifth torsion springs 22a, 22b, 22c, 22d and 22e) are compressed and deformed in the aforementioned action, torsional vibrations in occurrence of torque fluctuations can be attenuated. Additionally, when the inertia member 23 is actuated and the set of first and fourth torsion springs 22a and 22d and the set of second and fifth torsion springs 22b and 22e are bent and deformed, torsional vibrations in occurrence of torque fluctuations can be further attenuated.

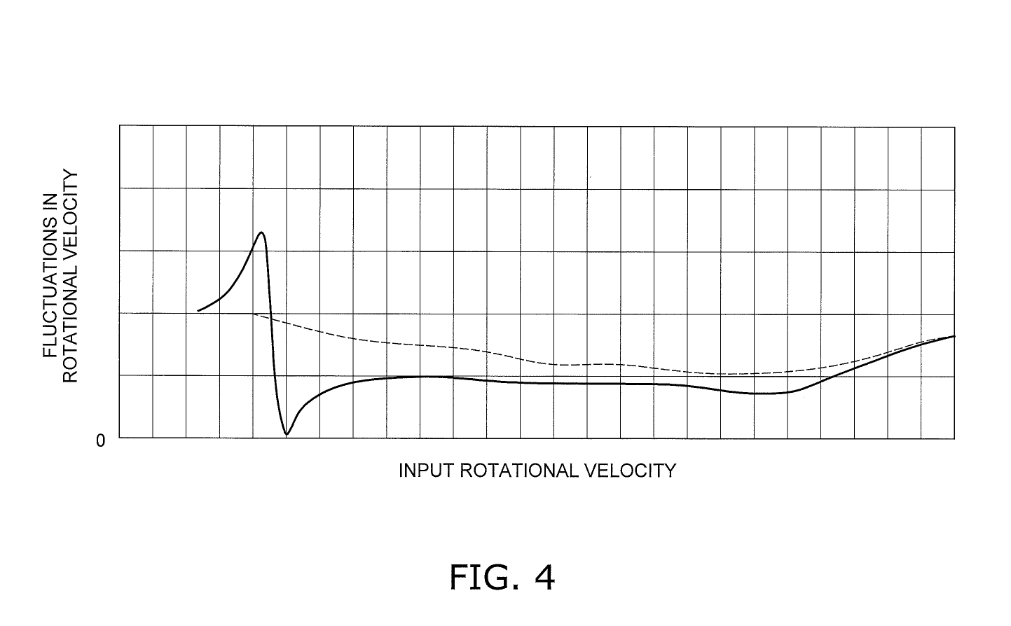

For example, FIG. 4 is a chart showing a relation between the input rotational velocity inputted to the first flywheel 5 from the engine and fluctuations in rotational velocity of the second flywheel 6. A solid line indicates a condition that the flywheel assembly 2 includes the inertia member 23. On the other hand, a broken line indicates a condition that the flywheel assembly 2 does not include the inertia member 23.

As is obvious from FIG. 4, in the present flywheel assembly 2, torsional vibrations in occurrence of torque fluctuations can be effectively attenuated. It should be noted that a trough in FIG. 4 is a part in which torsional vibrations in occurrence of torque fluctuations are most effectively attenuated by the actuation of the inertia member 23.

As described above, unlike the conventional art, the present flywheel assembly 2 can attenuate torsional vibrations in occurrence of torque fluctuations only by the sets of first and fourth torsion springs 22a and 22d and the sets of second and fifth torsion springs 22b and 22e without specially preparing torsion springs for actuating the inertia member 23. Thus, in the present flywheel assembly 2, the inertia member 23 can be actuated with a simple configuration. Additionally, with this configuration, the flywheel assembly 2 can be made compact.

### Other Exemplary Embodiments

The present disclosure is not limited to the aforementioned exemplary embodiment, and a variety of changes or modifications can be made without departing from the scope of the present disclosure.

(a) In the aforementioned exemplary embodiment, the flywheel assembly 2 has been explained as an exemplary power transmission device. However, the configuration of the power transmission device is not limited to that in the aforementioned exemplary embodiment, and is applicable to a variety of devices.

(b) The aforementioned exemplary embodiment has exemplified the configuration that a power outputted from the flywheel assembly 2 is transmitted to the clutch device. The clutch device encompasses, for instance, a lock-up device, a torque converter and so forth.

(c) The aforementioned exemplary embodiment has exemplified the configuration that the torsion springs, with which each second spring seat 41 is engaged, are the set of first and fourth torsion springs 22a and 22d and the set of second and fifth torsion springs 22b and 22e. Instead of this, the torsion springs, with which each second spring seat is engaged, can be only the set of first and second torsion springs 22a and 22b. In this case, the fourth and fifth torsion springs 22d and 22e are not used. Even in this configuration, it is possible to achieve advantageous effects similar to those achieved by the aforementioned exemplary embodiment.

### REFERENCE SIGNS LIST

2 Flywheel assembly
5 First flywheel
6 Second flywheel
7 Damper mechanism
21 Spring seat
22 Torsion spring
22a First torsion spring
22b Second torsion spring
22d Fourth torsion spring
22e Fifth torsion spring
23 Inertia member
41 Second spring seat
42 Engaging part
43 Positioning part

1. A power transmission device disposed between an engine and a transmission so as to be capable of attenuating fluctuations in torque, the power transmission device comprising:
an input rotary part to which the torque is inputted;
an output rotary part rotatable relatively to the input rotary part;
an elastic part for elastically coupling the input rotary part and the output rotary part in a rotational direction;
an inertia mass part movable in the rotational direction; and
an engaging part to be engaged with the elastic part and the inertia mass part, the engaging part for actuating the elastic part by relative rotation between the input rotary part and the output rotary part and movement of the inertia mass part.

2. The power transmission device according to claim 1, wherein the engaging part is capable of compressing the elastic part by the relative rotation between the input rotary part and the output rotary part, the engaging part capable of bending the elastic part by the movement of the inertia mass part.

3. The power transmission device according to claim 1, wherein the engaging part is pivotably engaged with the inertia mass part.

4. The power transmission device according to claim 1, wherein the engaging part makes contact with the elastic part.

5. The power transmission device according to claim 1, further comprising:
a positioning part for positioning the engaging part in a radial direction.

6. The power transmission device according to claim 5, wherein the positioning part further positions the elastic part in the radial direction.

7. The power transmission device according to claim 1, wherein the inertia mass part is disposed radially inside the engaging part.

8. The power transmission device according to claim 1, wherein the inertia mass part has an annular shape.

9. The power transmission device according to claim 1, wherein
the elastic part includes a first elastic part and a second elastic part, the second elastic part to be actuated in series with the first elastic part, and
the engaging part is disposed between the first elastic part and the second elastic part.
